(19) United States
(12) Patent Application Publication
(10) Pub. No.: US 2015/0227767 A1
(43) Pub. Date: Aug. 13, 2015

(54) RFID Reading Apparatus with State Display at an External Antenna

(71) Applicant: SICK AG, Waldkirch (DE)

(72) Inventors: Björn SOCK, Waldkirch (DE); Olaf PILZNER, Waldkirch (DE); Andreas GÜNTHER, Waldkirch (DE); Jan POTTHAST, Waldkirch (DE)

(21) Appl. No.: 14/608,552

(22) Filed: Jan. 29, 2015

(30) Foreign Application Priority Data
Feb. 13, 2014 (EP) 14155009.5

(51) Int. Cl. G06K 7/10

(52) U.S. Cl. CPC G06K 7/10009

(57) ABSTRACT

An RFID reading apparatus (10) is provided for reading RFID transponders (22) in a reading zone (24) in accordance with an RFID protocol, the RFID reading apparatus having an antenna (16, 26), a receiver (12, 18) for receiving RFID signals of the RFID transponders (22) with the aid of the antenna (16, 26) and an evaluation unit (12, 18) for reading a piece of RFID information from the received RFID signals, wherein the antenna (16, 28) is an external antenna (16) connected via a line (14) and has a display element (30) and/or has an operating element (32) which can be controlled by the evaluation unit (12, 18). In this respect, the external antenna (16) has a communication unit (28) for controlling the display element (30) and/or the operating element (32); and wherein the communication unit (28) is configured to communicate with the evaluation unit (12, 18) via the line (14) in accordance with the RFID protocol.

The invention relates to an RFID reading apparatus for reading RFID transponders in a reading zone in accordance with an RFID protocol with the aid of an external antenna as well as to a method for displaying and/or changing states of an external antenna in accordance with the preamble of claims 1 and 15 respectively.

RFID reading systems serve for the identification of objects and products and are used inter alia to automate logistical movements. RFID transponders fastened to the products are read out at an identification point, above all on a change of the owner of the product or on a change of the transport means, and information is optionally written back into the transponder. This results in fast and traceable logistical movements. The detected information is used to control the forwarding and sorting of goods and products. Important applications for automatic identification are logistical distribution centers, for instance of package shippers, or the baggage check-in at airports.

RFID transponders can be active in principle, that is they can have their own energy supply. In practice, however, these transponders are less suitable for logistics because the unit prices for such transponders cannot reach the low level required for the mass market due to the energy supply. Passive transponders without their own energy supply are therefore usually used. In both cases, the transponder is excited to radiate the stored information by electromagnetic radiation of the reading device, with passive transponders taking the required energy from the transmission energy of the reading system. In established ultrahigh frequency standards such as ISO 18000-C or EPC Generation 2 UHF RFID, passive transponders are read using the backscatter process.

A frequent deployment site of an RFID reading system is the installation at a conveyor belt on which the goods are conveyed or in a so-called reading portal. Any desired passageway is to be understood by this which is equipped with one or more RFID readers and possibly with further sensors. Objects are moved through the reading portal by means of a conveyor belt, by means of a transport vehicle such as a forklift, or also manually and are in so doing identified with reference to their RFID transponder.

To be able to be adapted to the local conditions, RFID reading apparatus are frequently used having one or more offset external antennas in order thus to achieve more flexible installation positions. A corresponding RFID reading apparatus which comprises both an internal antenna and an external antenna is known from DE 20 2010 008 162 U1, for example.

External antennas are usually passive components. It would, however, be desirable, also to display information, for example optical feedback via LEDs, at the external antenna. Even if the external antenna is now correspondingly upgraded so that it can take over its own signaling, measuring or control work, a communication connection must be built up due to the spatial separation from the actual RFID reading apparatus. This in turn causes a substantial effort for the establishing of a special communication protocol and for associated hardware and software in the RFID reading apparatus and in the external antenna. In addition, the backward compatibility between the RFID reading apparatus and external antennas is lost if the two cannot deal with the communication protocol. On using a separate communication line, a substantial increased effort in installation and servicing can be expected.

It is therefore the object of the invention to simplify the control of display elements or operating elements of the external antenna of an RFID reading apparatus.

This object is satisfied by an RFID reading apparatus for reading RFID transponders in a reading zone in accordance with an RFID protocol with the aid of an external antenna as well as by a method for displaying and/or changing states of an external antenna in accordance with claims 1 and 15 respectively. In this respect, a communication between the actual RFID reader and the external antenna connected thereto is established in order to satisfy different control and measurement work via this exchange of data. The invention starts from the basic idea of transmitting the communication via the same, already existing line via which the external antenna is connected. In this respect, the communication takes place via the RFID protocol which is already implemented in the RFID reader and with which RFID transponders are also read out, that is, for example, in accordance with ISO 18000-6 or EPC Generation-2 UHF RFID. Not only a separate communication line is thus dispensed with, but also the implementation of a new communication process for controlling the display elements or operating elements of the external antenna. In this respect, operating element very generally means either a setting possibility for a user or also internal switches, sensors and the like of the external antenna. Numerous examples of such control will still be given. Parameters and states of the external antenna or of the RFID reading apparatus are generally thereby set, changed or displayed.

The external antenna is to be distinguished from an internal antenna. This in particular means that the external antenna is not located in a housing with the evaluation unit of the RFID reader, but is rather spatially separated via the line, for example in its own housing. The communication unit of the external antenna and the evaluation unit of the RFID reader are accordingly separated from one another by the line. The external antenna in accordance with the invention in this respect comprises more than the purely antenna element, namely inter alia the communication unit and the display elements or operating elements.

The invention has the advantage that the same line, which is already present for connecting the external antenna can also be used for the communication and no increased effort for lines and their installation thereby arises. The use of the already implemented RFID protocol brings about the advantage, on the one hand, that all the effort for establishing a separate protocol is dispensed with. In addition, such a protocol would have to include measures to ensure the coexistence with a signal transmission of RFID signals from and to RFID transponders. This is also dispensed with on a use of the identical protocol. The RFID protocol can deal with colliding RFID signals because this problem has already been solved in connection with the simultaneous reading of a plurality of RFID transponders. In addition, the invention is backward compatible with any RFID reading apparatus according to the RFID protocol. A substantial added value arises by the display and operating elements at the external antenna, generally actuators and sensors.

The external antenna preferably has a coupling element in the line to couple signals of the communication unit onto the line or out of the line. The communication unit switches to the line between the RFID reader and the antenna using this coupling element which is a directional coupler, for example.

The communication unit preferably has an RFID transponder. Such RFID transponders are easily available and their technology is known since the RFID reader is anyway configured to read just such RFID transponders. It is therefore a particularly suitable means to implement the communication with the external antenna via the RFID protocol.

The external antenna preferably has a second evaluation unit for the local control. The external antenna therefore includes separate control and evaluation circuits independently of the evaluation unit of the RFID reader. This is particularly advantageous when the external antenna is to satisfy more complex tasks. A second evaluation unit just for the activation of display LEDs does not necessarily have to be provided, for example.

The communication unit preferably has a digital interface for connection to the second evaluation unit. The second evaluation unit can be linked directly and simply into the communication via this digital interface. For example, access to the communication unit takes place cyclically or in response to an interrupt which is triggered by a communication between the communication unit and the evaluation unit of the RFID reader.

The communication unit preferably has a modulator and demodulator unit. The second evaluation unit can emulate the RFID protocol with its aid. An RFID transponder chip in the external antenna is thus replaced.

The communication unit preferably has a memory. This memory is associated, above all functionally, with the communication unit. The memory can also be part of the second evolution unit physically, instead of in the communication unit, or can be a separate component. The memory serves to store the data to be communicated such as parameters, measured data, control information or states, and optionally also auxiliary values.

The communication unit is preferably configured to store antenna parameters in the memory or to read them out of it. This facilitates the diagnosis, setting up and maintenance of the external antenna since the antenna parameters can be read out or displayed at any time. How the older external parameter was parameterized is in particular known on an antenna exchange. These data are read into the RFID reader, for example, and are subsequently handed over to the new external antenna. Other parameters such as the antenna gain are only read so that the RFID reader can set the power accordingly. The same function is thereby automatically ensured or at least substantially facilitated.

The display element preferably has at least one LED. This is an inexpensive and robust manner, which is simple to detect, of displaying information. A plurality of LEDs or color LEDS can also be used to be able also to represent more complex information by spatial, temporal and color codes. Examples for information to be displayed in this manner are whether the antenna or the RFID reading apparatus is active, whether the last reading was successful, error states and the like.

The operating element preferably has at least one push button. In this respect, an operating button, a switch or the like is a comparatively simple element such as an LED with which now the user can conversely input commands to the external antenna or to the RFID reading apparatus by simple pressing. Such commands do not necessarily have to be restricted to binary inputs thanks to specific sequences. Examples for commands are the activation of the external antenna, a reset or the triggering of calibration functions or teach functions.

The external antenna preferably has a polarization switching element. Its polarization is thereby changed, for instance a change between linear and circular polarization or a change of direction of the polarization. This is helpful for test purposes and when the RFID transponders in the reading zone should have a specific preferred direction and the antenna should be set to it.

The external antenna preferably has a measurement element for measuring the radio frequency power. This measured value is displayed or is fed back to the RFID reading apparatus. An application example is the regulation of the antenna power to a desired value, in particular to a statutory limit value.

A switch is preferably arranged at the line for interrupting the connection to the antenna. This switch is even more preferably located directly in front of the actual antenna element. The switch should therefore not interrupt the communication connection, but rather only switch off the actual antenna signal or apply it to a terminal of the external antenna. The latter serves the purpose of operating a plurality of switchable external antennas at only one antenna port of the RFID reader.

A supply element is preferably provided at the line and supplies the external antenna with voltage. The external antenna preferably does not have a separate supply since this would again require a further line or additional effort for the provision of an autonomous energy source. In principle, the voltage supply can be decoupled from the radio frequency signals on the line, but then the external antenna and its components may only have a very low power take-up. Alternatively, there is a separate DC feed into the line, whether from the RFID reading apparatus or, where necessary, with an additional switch-on box.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

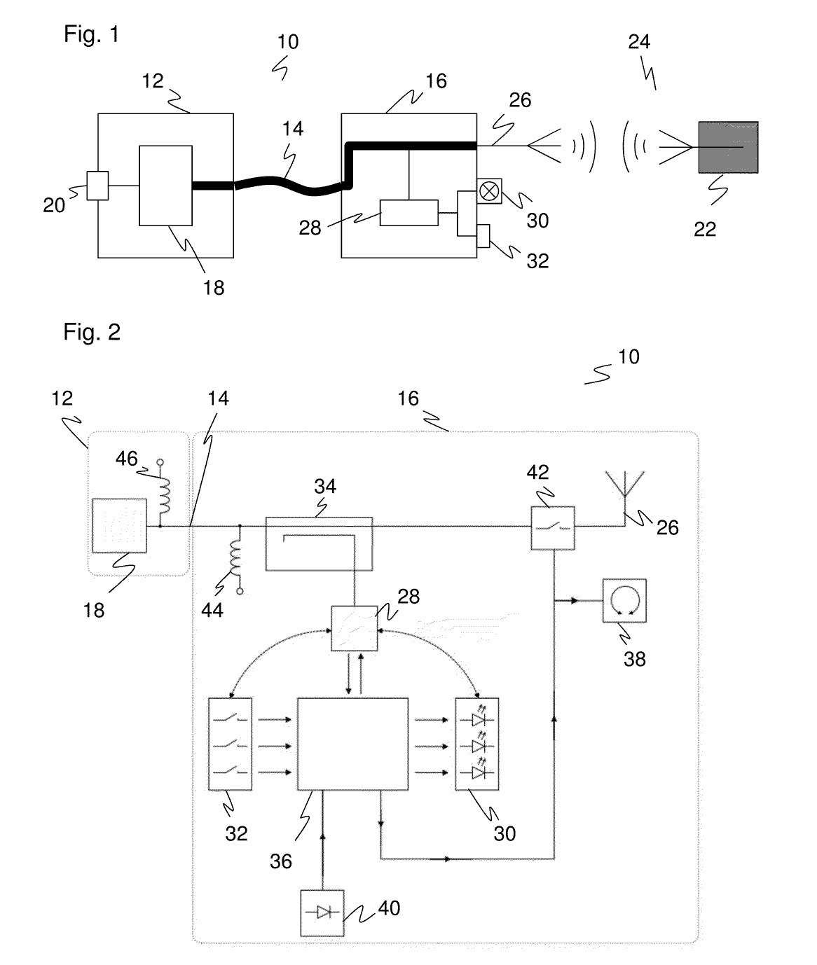

FIG. 1 a block diagram of an RFID reader with an external antenna;

FIG. 2 a block diagram of possible components of an external antenna; and

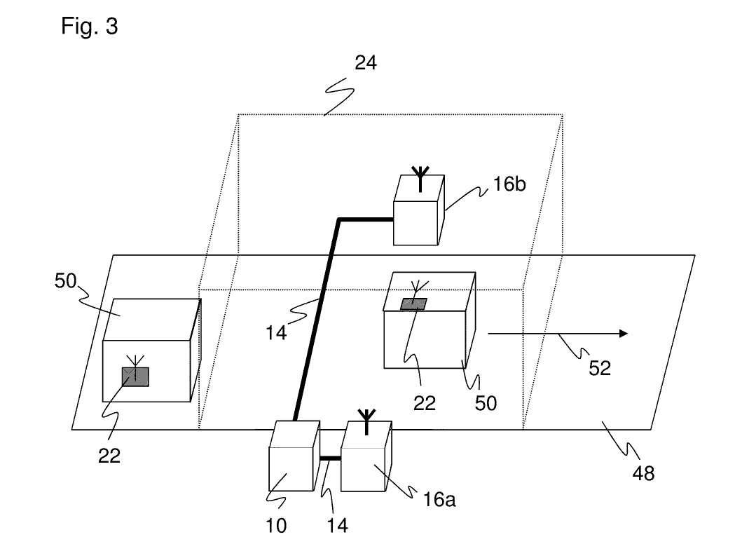

FIG. 3 a three-dimensional schematic representation of the assembly of an RFID reader with a plurality of external antennas at a conveyor belt.

FIG. 1 shows a block diagram of an RFID reading apparatus 10 with an actual RFID reader 12 and an external antenna 16 connected thereto via a line 14, preferably a coaxial line. The structure of the RFID reader 12 is largely assumed to be known. Only a reception unit and an evaluation unit 18 are shown, for example having a digital module such as a microprocessor or a FPGA (field programmable gate array) for evaluating and generating RFID signals, as well as a wired or wireless terminal 20 to integrate the RFID reading apparatus 10 into a higher-ranking system.

The RFID reading apparatus 10 serves to read out RFID information from transponders 22 in a reading zone 24 or to write RFID information into transponders 22. The communication takes place in accordance with a known RFID protocol, for instance ISO 18000-6 or EPC Generation-2 UHF RFID, and the steps and components required for this are known per se so that they will not be explained in more detail here. For the understanding of the invention, it is enough to know that the evaluation unit 18 of the RFID reader is capable of reading RFID information from an RFID signal received via an antenna element 26 of the external antenna 16 and the line 14 or conversely to encode RFID information into an RFID signal and to irradiate it via the antenna element 26.

In addition to the antenna element 2, which can also be configured as a patch antenna and integrated into the housing wall or into circuit boards, the external antenna 16 includes a communication unit 27 which is connected via the line 14 to the evaluation unit 18 of the RFID reader 12. The external antenna 16 is thereby connected to the RFID reader 12 via the same line 14 which also transmits the RFID signals of the antenna element 26 and thus to and from transponders 22 in the reading zone 24. Furthermore, the same RFID protocol is also used for this communication as on a communication between the RFID reader 12 and a transponder 22 in the reading zone 24, that is, for example, ISO 18000 or EPC Generation-2 UHF RFID.

The external antenna 16 can thereby be addressed from the RFID reader 12. This can inter alia be utilized to display parameters or states of the RFID reader 12 or of the antenna 16 at a display element 30 or to change them by an operating element 32. In FIG. 1, the display element 30 is shown purely by way of example as a lamp or LED and the operating element 32 is shown as a push button.

FIG. 2 shows a block diagram of an embodiment of the RFID reading apparatus 10 to explain possible components of the external antenna 16. In this respect, the same reference numerals designate the same or mutually corresponding features in this description.

The line 14 is connected to the communication unit 28 by a directional coupler 34. To control the function of the external antenna 16, a separate second evaluation unit 36 is provided therein which is connected to the communication unit 28 and to most of the further components of the external antenna 16 and which is preferably implemented on a digital module. In a simplified embodiment, the second evaluation unit 36 can be dispensed with. In this case, there is a direct connection of the communication unit 28 to the display elements 30 or to the operating elements 32, as shown by dashed arrows.

The communication unit 28 is configured in one embodiment as a transponder IC with an integrated digital interface for connection to the second evaluation unit 36. The protocol link alternatively takes place via the second evaluation unit 36 and a protocol emulation, with the communication unit 28 then acting as a modulator/demodulator.

The communication unit 28 has access to a memory which can be part of the communication unit 28 or of the second evaluation unit 36 or which can be a separate memory, not shown. It is particularly simple to directly use a specific region of the user memory of the transponder IC to which the communicated data such as control commands, states or measured values are written. Each data set, in particular each command and measured value, preferably has a known, agreed memory address.

Write access or read access to this memory can take place both via the air interface and in a wired manner. The RFID reader 12 can utilize the air interface via the antenna element 26 and the connection via the directional coupler 34; the second evaluation unit 36 can utilize its direct connection. In this respect, for example, the memory is cyclically checked for new content by the RFID reader 12. The second evaluation unit 36 reacts in dependence on the communication unit 28 used, in particular in dependence on whether and which transponder IC is provided therein, to an interrupt which was triggered by the access of the RFID reader 12 to the memory, or it likewise reads out the memory cyclically.

FIG. 2 shows a plurality of components which can be controlled via the communication unit 28 or via the second evaluation unit 36 and which will now be explained. In this respect, different embodiments are conceivable which only use some of these components.

One or more LEDs can be provided as the display element 30. Since the RFID signals, unlike, for example, visible light corresponding to optical sensors are not visually detectable, the operating state is signaled via LEDs. Corresponding LEDs at the RFID reader 12 itself would not be visible in the reading environment of the external antenna 16 in dependence on the spatial circumstances and the length of the line 14. The LEDs can only be switched on and off, but can also indicate more complex information by color gradations, flashing sequences and other activity patterns. The possible displays include the operating state (reading zone active or inactive), reading event successful/not successful, received signal strength indication (RSSI) as a color gradation, reading rate (response of a transponder over time) as a color gradation, antenna adaptation/returning power (VSWR) as a color gradation, hardware errors and so on.

FIG. 2 shows a plurality of push buttons as an exemplary operating element 32 for an interaction of the user with the RFID reader 12. The push buttons can be utilized, for example, in ongoing operation or for installing the RFID reader 12 or the external antenna 16, for switching on test modes, for triggering the activation of the reading zone 24 or for signaling the removal of a product directly at the location of the external antenna 16.

A polarization switch 38 is provided as a further possible element of the external antenna 16. Transponders 22 typically transmit a linearly polarized signal. If the preferred direction is known, the antenna element 16 can work with linear polarization of the corresponding alignment. Otherwise work is carried out using a circular polarization. Certain polarization properties provide advantages in the reading range depending on the position of the transponders 22. It can be sensible for this reason to switch over the polarization during installation or in operation. Conceivable switchable polarization states are: left circular, right circular, horizontal (linear) or vertical (linear).

The maximum transmission power of an RFID reading apparatus 10 prescribed by law relates to the power irradiated by the antenna element 26 (ERP or EIRP). This maximum transmission power should usually be fully utilized to read reliably and with a high reading range. Other desired values for the transmission power are also conceivable, however. The power generated in the RFID reader 12 and the antenna gain can be used as an approximation for the determination of the irradiated power. However, above all due to the losses of the line 14 of which not even the length is known as a rule, this does not correspond to the actual transmission power. A power sensor 40 can therefore be accommodated in the external antenna 16 which measures the power arriving at the antenna and reports it back to the RFID reader 12. The RFID reader 12 can thus regulate the power to compensate the power losses while maintaining the statutory limit values for the irradiated power.

It is possible with the aid of a controllable radio frequency switch 42 in the line 14 before the antenna element 26 to separate the antenna element 26 electrically or to switch over the signal to a terminal at a housing of the external antenna 16. A plurality of switchable external antennas 16 can thereby be operated at a single antenna port of the RFID reader 12. The separation of the antenna element 26 from the line 14 moreover offers the possibility of measuring the power losses addressed in the previous paragraph via the power of the reflected wave in the RFID reader 12.

There are a number of possibilities for the voltage supply of the external antenna 16. In this respect, a respective supply unit 44 of the external antenna 16 decouples the required voltage. The external antenna 16 can for this purpose utilize a portion of the radio frequency signal on the line 14, but this requires a very small power take-up of its components. The advantage in this respect is that now changes have to be made to the RFID reader 12, that is already present conventional RFID readers 12 cooperate with an external antenna 16 in accordance with the invention. Alternatively, a voltage is provided to the line 14 by a supply unit 46 of the RFID reader 12. The supply unit 46 can feed a voltage into the line 14 internally within the RFID reader 12, but also in a separate switch-on box. Whereas the internal solution requires a conversion of existing RFID readers 12, the switch-on box has to be additionally wired. It is therefore necessary to choose between the possibilities proposed here for the supply in dependence on the application.

The memory of the communication unit 28 can also be used to store antenna parameters. After the installation of an external antenna 16, it is checked for a correct function on a final tester and the antenna gain is inter alia taken up in so doing. The antenna gain and further antenna parameters are written into the memory and are later polled by the RFID reader 12. The calculation of the irradiated power for each external antenna 16 can thereby take place individually, tolerances between different antennas are taken into account and the respective external antenna 16 can be operated closer to the statutory limit value, for example. On a replacement of antennas, the replacement antenna can be set in a simple manner such that it in particular generates an electromagnetic field of the same strength as the original antenna by using a stored individual antenna gain. Some further possible antenna parameters which can likewise be stored and can be used by the RFID reader 12 are: radiation resistance, impedance, efficiency, rectification factor, absorption area or effective area or bandwidth, additionally typical VSWR or polarization, that is, for instance, whether the antenna has switchable polarization properties or only supports horizontal, vertical, or circular. Instead of the antenna parameters themselves, prepared parameters can also be used, that is values which should be used in the RFID reader when it cooperates with the corresponding antenna. Alternatively, the RFID reader 12 determines such values with reference to the antenna parameters themselves. The RFID reader 12 can also note with reference to the antenna parameters that a replacement antenna is not compatible with the original antenna and requires a repeat replacement. For this purpose, instead of physical parameters, artificial codes can also be used for specific antenna families.

FIG. 3 shows an overview representation of an RFID reading apparatus 10 having two external antennas 16a-b which are installed at both sides of a conveyor 48 which conveys objects 50 with transponders 22 in a direction through the reading zone 24 marked by an arrow 52. It is the object of the RFID reading apparatus in this application to identify the objects 50 in that information is read out of the transponders 22 and is optionally also changed and written back. The reading zone 24 can be protected by an electromagnetic shield and thus form a reading tunnel. Further sensors are frequently installed at the reading tunnel, in addition to the RFID reading apparatus, to obtain additional information on the objects 50, for example their entry into and exit from the reading zone 24 or the volume or weight of the objects 50.

Alternatively to the use of the same protocol for the communication between the RFID reader 12 and the external antenna 16 and the communication with transponders 22 in the reading zone 24, an additional protocol can be utilized which is modulated onto a lower-frequency carrier, such as DiSEqC. For very simple control work, it would also be possible to apply a switchable DC voltage onto the line 14 and to control different LEDS in dependence on the level. However, both have to be implemented separately and this is much less robust and flexible.

1. An RFID reading apparatus for reading RFID transponders in a reading zone in accordance with an RFID protocol, the RFID reading apparatus having an antenna, a receiver for receiving RFID signals of the RFID transponders with the aid of the antenna and an evaluation unit for reading a piece of RFID information from the received RFID signals, wherein the antenna is an external antenna connected via a line and has at least one of a display element and an operating element which can be controlled by the evaluation unit,
wherein the external antenna has a communication unit for controlling the at least one of the display element and the operating element; and wherein the communication unit is configured to communicate with the evaluation unit via the line in accordance with the RFID protocol.

2. The RFID reading apparatus in accordance with claim 1,
wherein the external line has a coupling element in the line to couple signals of the communication unit onto the line or to decouple them out of the line.

3. The RFID reading apparatus in accordance with claim 1,
wherein the communication unit has an RFID transponder.

4. The RFID reading apparatus in accordance with claim 1,
wherein the external antenna has a second evaluation unit for local control.

5. The RFID reading apparatus in accordance with claim 4,
wherein the communication unit has a digital interface for connecting to the second evaluation unit.

6. The RFID reading apparatus in accordance with claim 1,
wherein the communication unit has a modulator unit and a demodulator unit.

7. The RFID reading apparatus in accordance with claim 1,
wherein the communication unit has a memory.

8. The RFID reading apparatus in accordance with claim 7,
wherein the communication unit is configured to store antenna parameters in the memory or to read antenna parameters out of the memory.

9. The RFID reading apparatus in accordance with claim 1,
wherein the display element has at least one LED.

10. The RFID reading apparatus in accordance with claim 1,
wherein the operating element has at least one push button.

11. The RFID reading apparatus in accordance with claim 1,
wherein the external antenna has a polarization switching element.

12. The RFID reading apparatus in accordance with claim 1,
wherein the external antenna has a measurement element for measuring the radio frequency power.

13. The RFID reading apparatus in accordance with claim 1,
wherein a switch for interrupting the connection to the external antenna is arranged at the line.

14. The RFID reading apparatus in accordance with claim 1,
further comprising a supply element, the supply element supplying the external antenna with voltage and being arranged at the line.

15. A method for displaying and/or changing states of an external antenna which is connected via a line to an RFID reader for reading RFID transponders in a reading zone in accordance with an RFID protocol by means of at least one of a display element and an operating element of the external antenna, said element being controlled via the line,
wherein the at least one of the display element and the operating element is controlled via a communication unit of the external antenna which communicates with the RFID reader via the line in accordance with the RFID protocol.
